(19) United States
(12) Patent Application Publication
(10) Pub. No.: US 2019/0015738 A1
(43) Pub. Date: Jan. 17, 2019

(54) Gyroscope Apparatus System for Immersing Users Into a Virtual Reality Environment

(71) Applicant: Roelof Bootsma, Vancouver (CA)

(72) Inventor: Marcus A LeVere, Vancouver (CA)

(73) Assignee: Roelof Bootsma, Vancouver (CA)

(21) Appl. No.: 15/650,733

(22) Filed: Jul. 14, 2017

(51) Int. Cl. A63F 13/211; A63F 13/25; A63F 13/803

(52) U.S. Cl. CPC A63F 13/211; G06F 3/0346; A63F 13/803; A63F 13/25

(57) ABSTRACT

An apparatus that immerses the user into a virtual reality environment where the user can train by themselves or compete with others in the same or other locations, enhanced by the principles of a gyroscope combined with the principles of simulation and virtual reality. The invention can be employed for entertainment, physical exercise, and competitive sports. A user of this invention has the capability of undergoing complex three hundred and sixty degree motions because of the gyroscopic aspects of the apparatus in conjunction with cable robots, exo skeleton human-computer interface, and virtual reality head mounted displays.

### RELATED APPLICATIONS

The present application is a continuation-in-part application of U.S. provisional patent application, Ser. No. 62/363,767, filed Jul. 18, 2016, for GYROSCOPE APPARATUS FOR IMMERSING ATHLETES INTO A VIRTUAL REALITY ENVIRONMENT, by Marcus A LeVere, included by reference herein and for which benefit of the priority date is hereby claimed.

### FIELD OF THE INVENTION

The present invention relates to a system and, more particularly, to a gyroscope apparatus system for immersing users into a virtual reality environment.

### BACKGROUND OF THE INVENTION

Though the use of gyroscopes in toys, amusement devices and virtual reality products has gained in popularity and though virtual reality software and renderings has become more sophisticated over time, no apparatus has been invented that that allows a user to be so immersed in virtual reality that they can jump, run and throw things in virtual space.

In prior art such as those below the user is always limited to sitting, or to lying or to walking in limited motion.

Gyroscope Exercise Device Kuntz US Pat No. 2014/0213417 A1 describes a device related to an exercise machine that uses the principles of a gyroscope combined with the principles of simulation and virtual reality to provide a body workout as well as balance training for sports such as river boarding, body boarding, sledding and other similar activities.

Gyroscopic Amusement Apparatus Nagel U.S. Pat. No. 5,759,107 describes a gyroscopic amusement apparatus constructed to provide an improved amusement ride for an operator through the use of a control stick to control the rotation of the gyroscopic rings mounted on a hydraulically operated motion based platform combined with a virtual reality head mounted display (HMD). In this gyroscopic amusement machine, the operator is confined to a seat and is restricted to remain seated while rotating in two axis within the circular rings of the gyroscopic machine.

System for Placing A Subject Into Virtual Reality—Latypov U.S. Pat. No. 6,563,489 B1 describes system where the user is inside a sphere shaped closed capsule installed on supports so that to rotate around its centre, and having a hatch with a door for entry and exit of the user.

The present invention relates generally to gyroscopic virtual reality systems and more specifically it relates to a gyroscope apparatus for immersing users into a virtual reality environment, to exercise and compete in a virtual arena enhanced by the principles of a gyroscope combined with the principles of simulation and virtual reality.

would be advantageous to provide an immersion into a virtual environment where the user can run, jump, and throw in six dimensions.

It would also be advantageous to provide an immersion into a virtual environment where the user can surf around Mars or play three dimensional football.

It would further be advantageous to provide a. gyroscope apparatus that has an axis of rotation added to enhance immersion in virtual reality.

### SUMMARY OF THE INVENTION

In accordance with the present invention, there is provided an apparatus system that immerses the user into a virtual reality environment where the user can train by themselves or compete against others in other locations enhanced by the principles of a gyroscope combined with the principles of simulation and virtual reality. The present invention addresses the following advantages

### BRIEF DESCRIPTION OF THE DRAWINGS

A complete understanding of the present invention may be obtained by reference to the accompanying drawings, when considered in conjunction with the subsequent, detailed description, in which:

FIG. 1 is a general view of a gyroscope apparatus for immersing users into a virtual reality environment, in accordance with the present invention;

FIG. 2 is an exploded view of a gyroscopic apparatus system with all its components in accordance ithe the present invention;

FIG. 3 is a left sectional view of a gyroscopic apparatus showing the location of the exo-suit which the user would be wearing as well as the gyroscope rotor, gimbal ring and cable robot attachment in the present invention;

FIG. 4 is a right sectional view of a gyroscopic apparatus showing the exo-suit;

FIG. 5 is a left perspective view of a gyroscopic apparatus showing gyroscope rotor, gimbal ring and cable robot attachment of the present invention;

FIG. 6 is a right perspective view of a gyroscopic apparatus showing gyroscope rotor, gimbal ring and cable robot attachment of the present invention;

FIG. 7 is a left sectional view of a gyroscopic apparatus showing gyroscope rotor, gimbal ring and cable robot attachment as well as the location of the exo suit in the present invention;

FIG. 8 is a right sectional view of a gyroscopic apparatus of the present invention;

FIG. 9 is a left perspective view of a gyroscopic apparatus showing gyroscopic rotor, gimbal ring and cable robot attachment of the present invention;

FIG. 10 is a right elevation view of an of the present invention;

FIG. 11 is a bottom elevation view of a gyroscopic apparatus showing gyroscopic rotor, gimbal ring and cable robot attachment of the present invention;

FIG. 12 is a bottom perspective view of a gyroscopic apparatus showing gyroscopic rotor, gimbal ring and cable robot attachment of the present invention; and

FIG. 13 is a perspective view of a several gyroscopic apparatuses used in competition in a physical non-virtual arena.

For purposes of clarity and brevity, like elements and components will bear the same designations and numbering throughout the Figures.

### DESCRIPTION OF THE PREFERRED EMBODIMENT

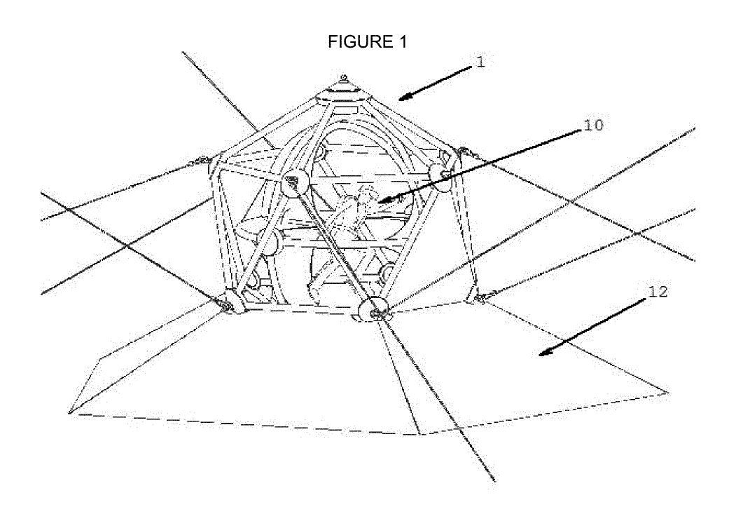

FIG. 1 is a general view of gyroscope apparatus 1 for immersing users into a virtual reality environment, in accordance with the present invention.

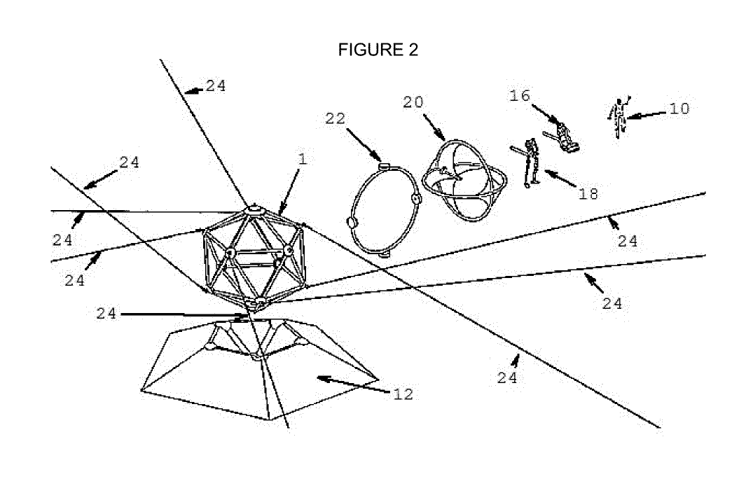

FIG. 2 is an exploded view of a gyroscopic apparatus system with all its components in accordance with the present invention. It shows the user or pilot 10, so described because the user pilots the apparatus using the exo suit harness 18. FIG. 2 also shows the seat 16, the gyroscope rotor 20, and gimbal ring 22 which is housed in the gyroscope apparatus 1. The gyroscope apparatus 1 is translated through the air by eight cables 24. The eight cables 24 are attached to eight winches acting as a cable robot like the CableRobot simulator developed by the Max Planck Institure for Biological Cybernetics in 2015. Also in FIG. 2 is the exo suit harness 18 worn by the user or pilot 10. The exo suit harness 18 is a human-computer interface that allows the user to interact with and be in the virtual reality program. As its basis, it is a head mounted display, sensory hand input controllers and biofeedback sensors to track pulse, temperature, muscle tension, respiratory rate and brain activity that would adjust the virtual reality displayed to the user or pilot 10. Motion capture flows from the exo suit harness 18, and haptic feedback flows to the exo suit harness 18. The exo suit harness 18 is constantly being redeveloped and therefore is interchangeable as technology changes. In its latest development by U.S. Pat. No. 9,652,037 B2 Rubin et al Whole-Body Human Computer Interface, the exo suit harness 18 is a complete exoskeleton allowing the user or pilot 10 complete articulation. The gyroscope apparatus 1 sits on a launch pad 12. This launch pad 12 supports the gyroscope apparatus 1 at rest, aids the user or pilot 10 entry and is a storage unit.

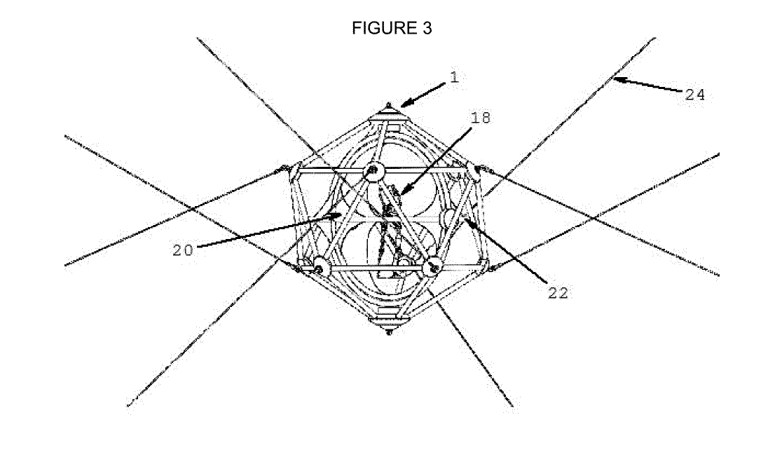

FIG. 3 is a left sectional view of a gyroscopic apparatus showing the location of the exo suit harness 18 which the user would be wearing as well as the gyroscope rotor 20, gimbal ring 22 and cables 24 for the cable robot assembly in the present invention. The gyroscope rotor has an extra axis. Combining this gyroscope rotor 20 with the gimbal ring 22 and the cables 24 for the robot assembly results in the user or pilot 10 being able to run, jump and even throw virtual things in six dimensions.

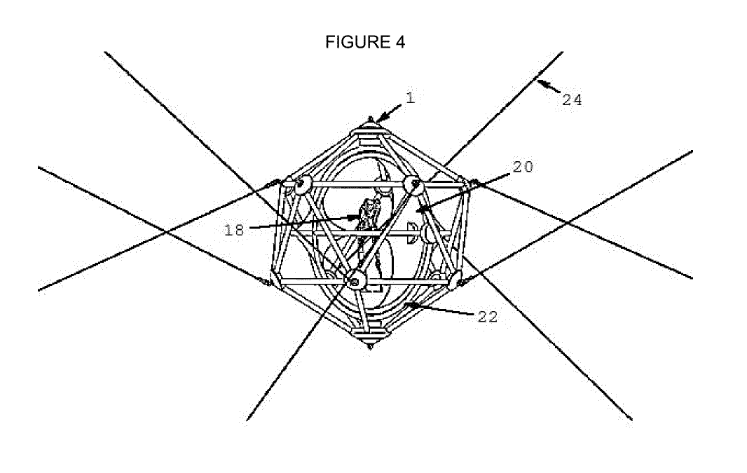

FIGS. 4 to 12 show the gyroscope apparatus 1 in motion as the exo suit harness 18 keeps the center perspective while the gyroscope rotor 20, the gimbal ring 22 and cables 24 move.

FIG. 4 is a right sectional view of a gyroscopic apparatus showing the exo suit harness 18. It also gives a perspective of the gyroscope rotor 20, gimbal ring 22. and cables 24 for the cable robot assembly.

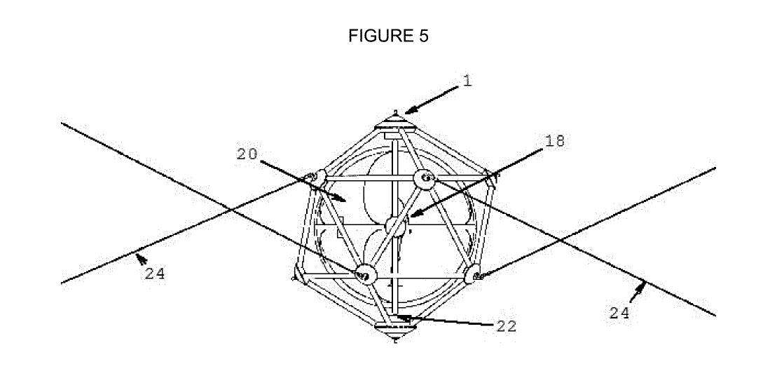

FIG. 5 is a left perspective view of a gyroscopic apparatus showing the exo suit harness 18 gyroscope rotor 20, gimbal ring 22 and cables 24 for the cable robot assembly of the present invention

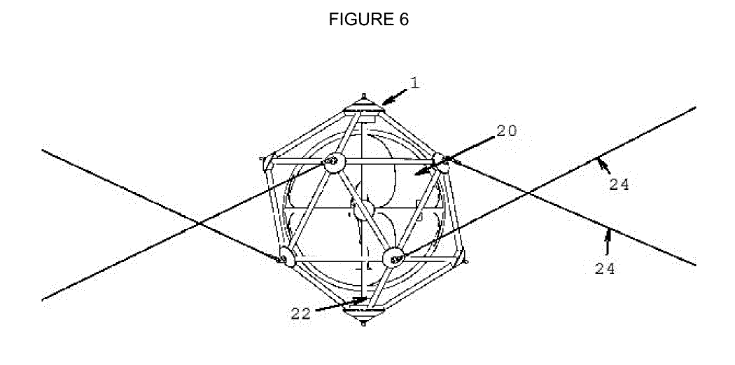

FIG. 6 is a right perspective view of a gyroscopic apparatus gyroscope rotor 20, gimbal ring 22 and cables 24 for the cable robot assembly of the present invention

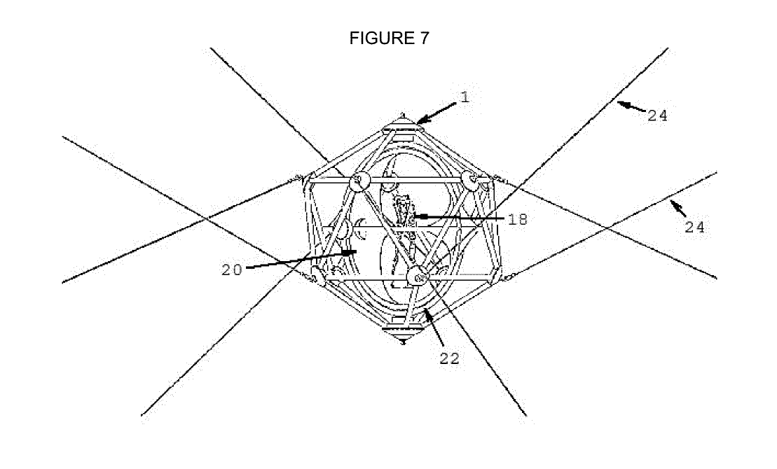

FIG. 7 is a left sectional view of a gyroscopic apparatus showing gyroscope rotor 20, gimbal ring 22 and cables 24 for the cable robot assembly as well as the location of the exo suit harness 18 in the present invention

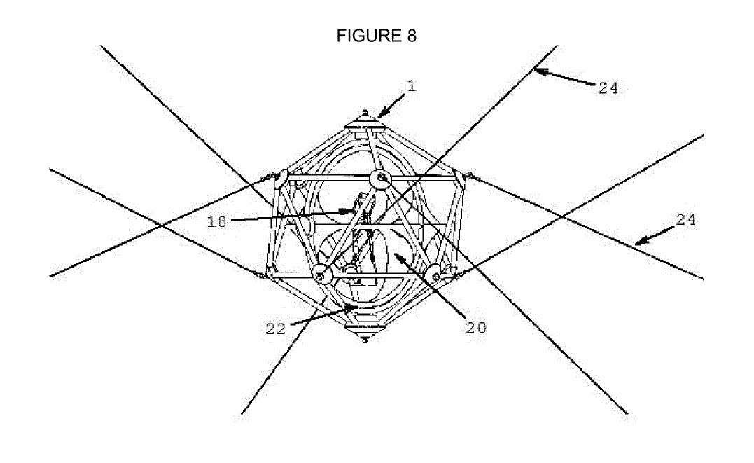

FIG. 8 is a right sectional view of a gyroscopic apparatus.

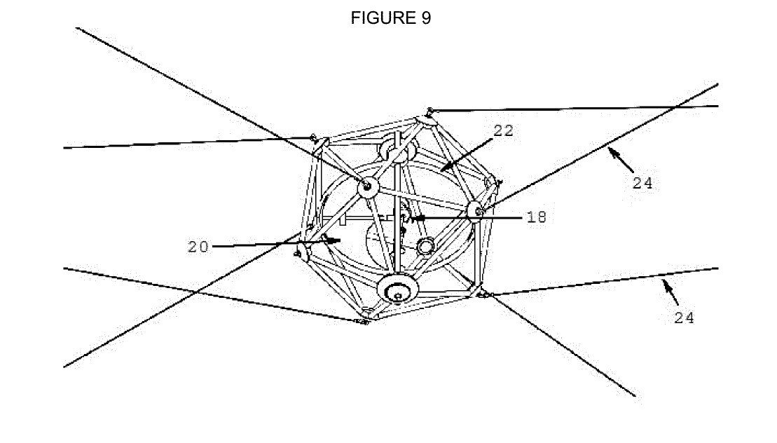

FIG. 9 is a left perspective view of a gyroscopic apparatus showing gyroscope rotor 20, gimbal ring 22 and cables 24 for the cable robot assembly of the present invention

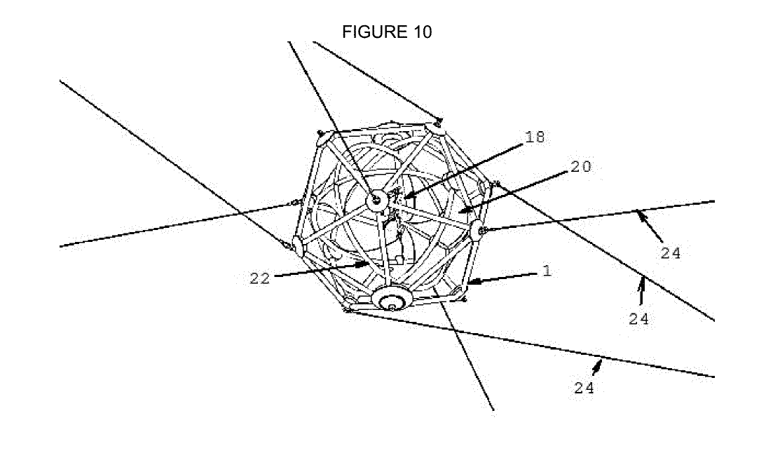

FIG. 10 is a right elevation view of a gyroscopic apparatus. of the present invention

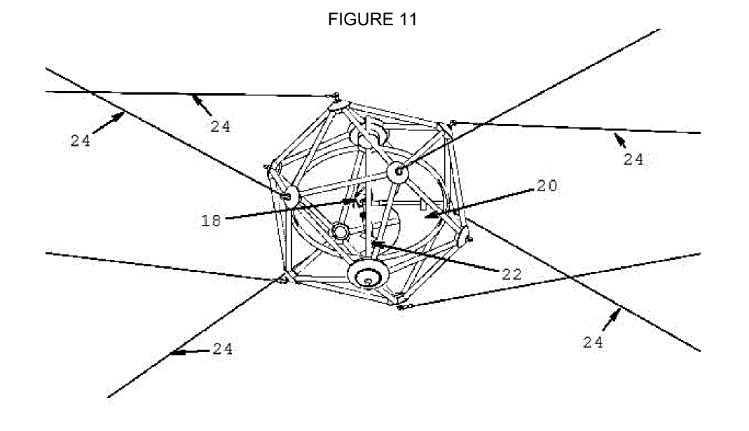

FIG. 11 is a bottom elevation view of a gyroscopic apparatus. showing the exo suit harness 18, gyroscope rotor 20, gimbal ring 22 and cables 24 for the cable robot assembly of the present invention

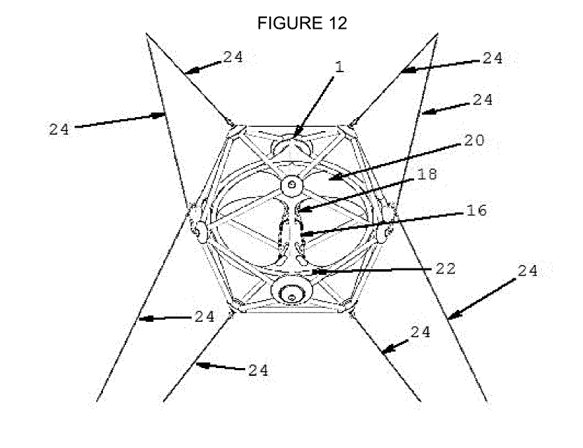

FIG. 12 is a bottom perspective view of a gyroscopic apparatus. showing the exo suit harness 18, gyroscope rotor 20, gimbal ring 22 and cables 24 for the cable robot assembly of the present invention

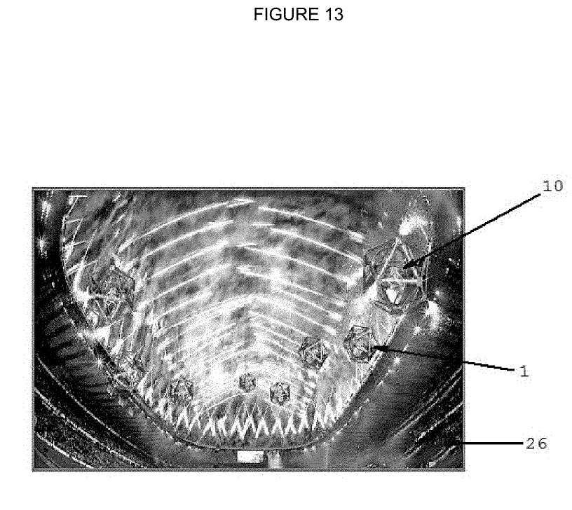

FIG. 13 is a perspective view of several gyroscopic apparatuses used in competition in a real arena 26. One of the potentialities of this invention is that it can be grouped in teams for a combination esport and real sport phenomenon

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A gyroscope apparatus system for immersing users into a virtual reality environment, comprising:
means for housing all the system components;
means for operating or piloting the apparatus through virtual reality simulation;
means for holding apparatus, releasably based to said means for housing all the system components;
means for the user to sit or stand, temporarily attached to said means for operating or piloting the apparatus through virtual reality simulation;
means for communicating with the virtual reality programs, manually fitted to said means for operating or piloting the apparatus through virtual reality simulation;
means for the user to sit in his exo suit harness, independently connected to said means for communicating with the virtual reality programs, independently connected to said means for the user to sit or stand, and operatively housed to said means for housing all the system components;
means for tilting the apparatus freely in any direction, rotationally connected to said means for the user to sit in his exo suit harness;
means for attaching to a cable robot, swingably fastened to said means for housing all the system components;
means for use in competition with others in real and virtual spaces;
means for use in competition against others in real and virtual arenas; and
means for use in unison with others inside the apparatus.

2. The gyroscope apparatus system in accordance with claim 1, wherein said means for housing all the system components comprises a gyroscope apparatus.

3. The gyroscope apparatus system in accordance with claim 1, wherein said means for operating or piloting the apparatus through virtual reality simulation comprises an user or pilot.

4. The gyroscope apparatus system in accordance with claim 1, wherein said means for holding apparatus comprises a launch pad.

5. The gyroscope apparatus system in accordance with claim 1, wherein said means for the user to sit or stand comprises a seat.

6. The gyroscope apparatus system in accordance with claim 1, wherein said means for communicating with the virtual reality programs comprises an exo suit harness.

7. The gyroscope apparatus system in accordance with claim 1, wherein said means for the user to sit in his exo suit harness comprises a gyroscope rotor.

8. The gyroscope apparatus system in accordance with claim 1, wherein said means for tilting the apparatus freely in any direction comprises a gimbal ring.

9. The gyroscope apparatus system in accordance with claim 1, wherein said means for attaching to a cable robot comprises a cables.

10. The gyroscope apparatus system in accordance with claim 1, wherein said means for use in competition with others in real and virtual spaces comprises an arena.

11. The gyroscope apparatus system in accordance with claim 1, wherein said means for use in competition against others in real and virtual arenas comprises a space.

12. The gyroscope apparatus system in accordance with claim 1, wherein said means for use in unison with others inside the apparatus comprises an unison.

13. A gyroscope apparatus system for immersing users into a virtual reality environment, comprising:
a gyroscope apparatus, for housing all the system components;
an user or pilot, for operating or piloting the apparatus through virtual reality simulation;
a launch pad, for holding apparatus, releasably based to said gyroscope apparatus;
a seat, for the user to sit or stand, temporarily attached to said user or pilot;
an exo suit harness, for communicating with the virtual reality programs, manually fitted to said user or pilot;
a gyroscope rotor, for the user to sit in his exo suit harness,
independently connected to said exo suit harness, independently connected to said seat, and operatively housed to said gyroscope apparatus;
a gimbal ring, for tilting the apparatus freely in any direction, rotationally connected to said gyroscope rotor;
a cables, for attaching to a cable robot, swingably fastened to said gyroscope apparatus;
an arena, for use in competition with others in real and virtual spaces;
a space, for use in competition against others in real and virtual arenas; and
an unison, for use in unison with others inside the apparatus.

14. A gyroscope apparatus system for immersing users into a virtual reality environment, comprising:
a gyroscope apparatus, for housing all the system components;
an user or pilot, for operating or piloting the apparatus through virtual reality simulation;
a launch pad, for holding apparatus, releasably based to said gyroscope apparatus;
a seat, for the user to sit or stand, temporarily attached to said user or pilot;
an exo suit harness, for communicating with the virtual reality programs, manually fitted to said user or pilot;
a gyroscope rotor, for the user to sit in his exo suit harness, independently connected to said exo suit harness, independently connected to said seat, and operatively housed to said gyroscope apparatus;
a gimbal ring, for tilting the apparatus freely in any direction, rotationally connected to said gyroscope rotor;
a cables, for attaching to a cable robot, swingably fastened to said gyroscope apparatus;
an arena, for use in competition with others in real and virtual spaces;
a space, for use in competition against others in real and virtual arenas; and
an unison, for use in unison with others inside the apparatus.
